(19) United States
(12) Patent Application Publication
(10) Pub. No.: US 2005/0045646 A1
(43) Pub. Date: Mar. 3, 2005

(54) Shock absorbent end cap for trays

(76) Inventor: Robert J. White JR., Tracy, CA (US)

Correspondence Address: PILLSBURY WINTHROP LLP, 2550 Hanover Street, Palo Alto, CA, 94304, US

(21) Appl. No.: 10/654,865

(22) Filed: Sep. 3, 2003

(51) Int. Cl. A47J 39/00

(52) U.S. Cl. 220/694

(57) ABSTRACT

In one embodiment of the present invention, an end cap is provided in the form of a box with an open top, having a substantially rectangular base and four substantially rectangular sides, each attached to one of four corresponding edges of the base. The end cap open top has interior length and width dimensions providing clearance for a corresponding width and height respectively of a stack of trays. A depth of the inside of the end cap allows insertion of an end portion of the stack of trays. The end cap is constructed from a shock, absorbent material of thickness and material properties designed to absorb shock for the purpose of protecting the trays and components in the trays. Shock absorbing end caps are placed over both ends of a stack of trays, and the assembly is placed in a dry-pack bag and sealed, and then placed in a cardboard box for transportation.

### BACKGROUND OF THE INVENTION

1. Field of the Invention

The present invention relates to methods and apparatus for protecting a stack of trays holding components such as semiconductors, and more particularly to a shock absorbing end cap that fits over end portions of the stack of trays.

2. Description of the Related Art

Trays for storing and transporting small components such as semiconductors are generally stacked in quantities of two or more trays. The stack is then secured by wrapping it, for example with straps, or/and secured with end caps. For transportation, the stack is placed in a box, surrounded with shock absorbing material such as foam or bubble wrap, etc. The addition of foam or bubble wrap requires larger boxes, which consume more storage space, which is a disadvantage. On occasion, the stacks are boxed with inadequate shock absorbing material, resulting in damage to the trays and components in the process of handling and transportation.

### SUMMARY

It is an advantage of the present invention that it allows smaller sized boxes to be used in the transport and storage of stacks of trays.

It is a further advantage of the present invention in that shock absorbing packaging material is not generally required to assure protection during handling and transportation of stacks of trays.

The above advantages, among others, can be achieved singly or in combination.

In one embodiment of the present invention, an end cap is provided in the form of a box with an open top, having a substantially rectangular base and four substantially rectangular sides, each attached to one of four corresponding edges of the base. The end cap open top has interior length and width dimensions providing clearance for a corresponding width and height respectively of a stack of trays. A depth of the inside of the end cap allows insertion of an end portion of the stack of trays. The end cap is constructed from a shock, absorbent material of thickness and material properties designed to absorb shock for the purpose of protecting the trays and components in the trays. Shock absorbing end caps are placed over both ends of a stack of trays, and the assembly is placed in a dry-pack bag and sealed, and then placed in a cardboard box for transportation.

### BRIEF DESCRIPTION OF THE DRAWINGS

FIG. 1 shows an end cap according to the present invention;

FIG. 2 illustrates end caps installed on ends of a stack of trays according to a method of the present invention;

FIG. 3 is a cross sectional view showing a stack of trays with end caps, installed in a box for storage or shipment;

FIG. 4A illustrates an end cap constructed of shock absorbing and non-shock absorbing materials; and

FIG. 4B is a cross sectional view of FIG. 4A.

### DESCRIPTION OF THE PREFERRED EMBODIMENTS

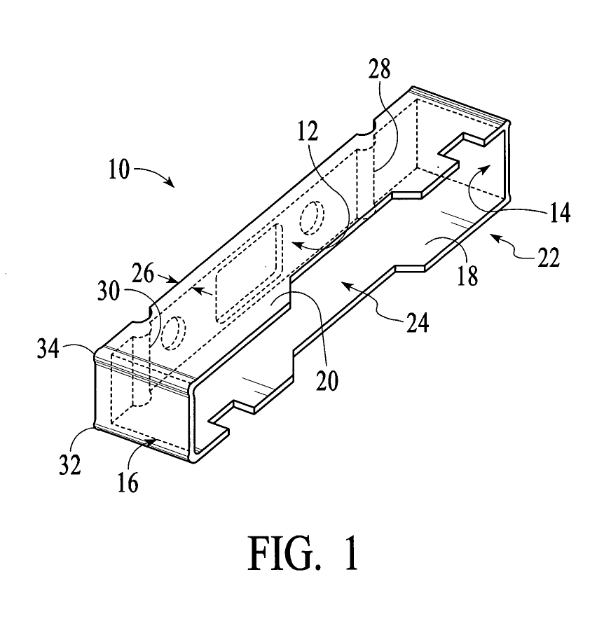

FIG. 1 shows an end cap 10 according to the present invention, in the form of a box-like structure having a substantially rectangular base 12, and four walls 14, 16, 18 and 20, each extending from an edge of the base to an open end 22. The end cap 10 forms a cavity 24, and is for placement over an end portion of a stack of trays. The end cap 10 is constructed of shock absorbing material, such as rubber or any of various other materials for the purpose of absorbing shock that will be understood by those skilled in the art. The optimum choice of material and thickness such as wall thickness 26 for example, will depend on the combined weight of a tray stack with components. The calculations for determining the optimum material and thickness will be understood by those skilled in the art, and need not be described for any particular sizes and weights in order for the present invention to be understood and implemented. A shock absorbing material by definition in the present disclosure includes materials that will be recognized by those skilled in the art for such a purpose, and is generally a compressible, and somewhat resilient material, in contrast to relatively non-compressible materials such as hard plastic and metal.

The shape of the end cap 10 as shown in FIG. 1 is given by way of example. Various other shapes that conform to the shape at an end of a stack of trays will also be effective for the purpose, as should be understood by reading the present disclosure.

FIG. 1 shows protrusions 28 and 30 of shock absorbing material extending from the back wall 12 into the cavity 24, for the purpose of supporting the more substantial end portion of a tray on each side of an elongated tab-like protrusion that is often included on a molded tray.

Various alternative configurations of the cap wall 12 for supporting the tray in general, and in one particular embodiment for also protecting the tab protrusion, will be apparent to those skilled in the art, and these alternatives are included in the spirit of the present invention. The cap 10 as shown in FIG. 1 has enhanced material thickness at the corners 32 and 34, giving added protection to the more vulnerable/fragile corners of the trays.

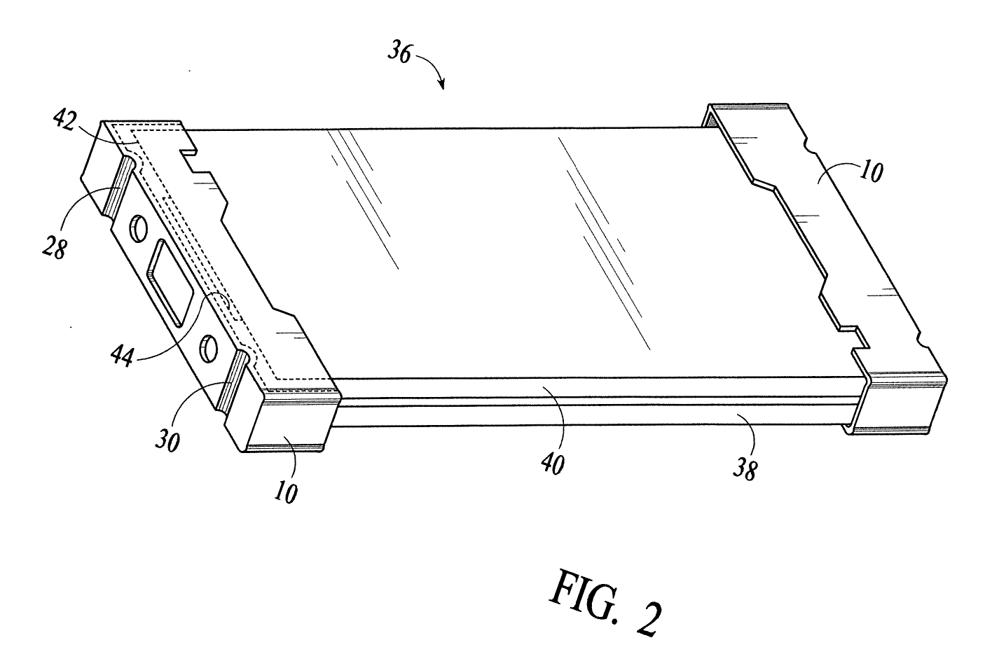

FIG. 2 illustrates the method of the present invention wherein an end cap 10 is placed over each of the two ends of a stack 36 of trays. Although two trays, or a tray and cover are symbolically illustrated as items 38 and 40, the present invention includes end caps designed for use on stacks of any number of trays and tray covers. FIG. 2 also shows the alternative protrusions 28 and 30, dimensional to give support to the end portions 42 of the trays and to provide clearance for and therefore protect the elongated tab extension/protrusion 44.

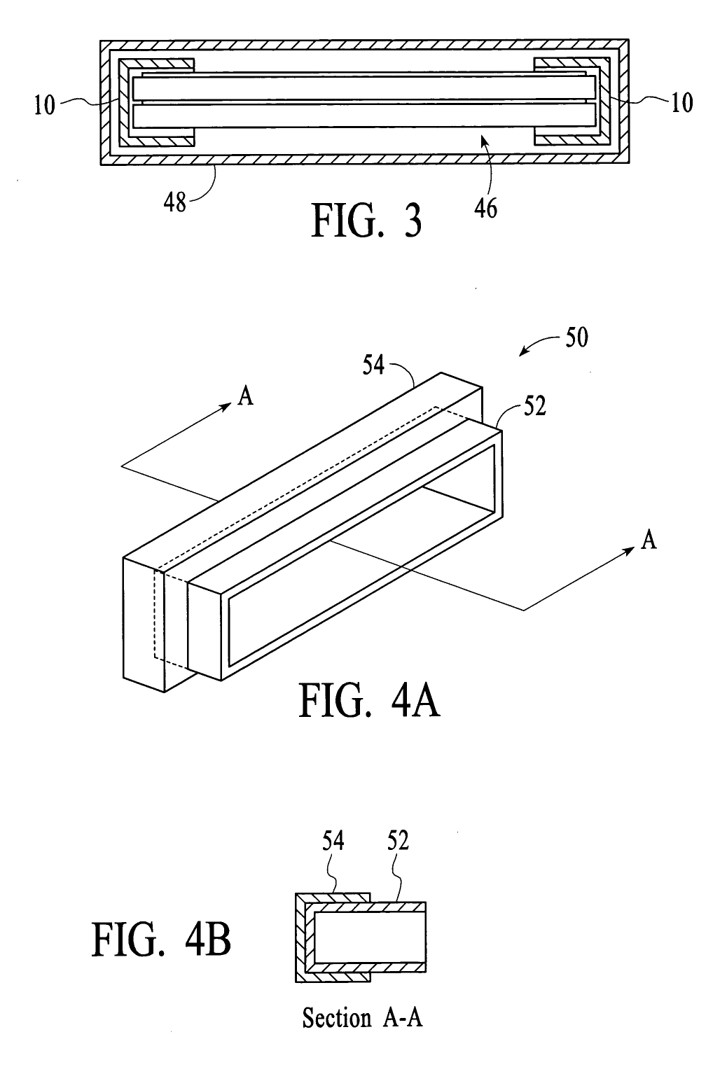

FIG. 3 is a cross sectional view of an assembly of a stack 46 of trays or trays and cover, with shock absorbent end caps 10, enclosed in a box 48 for storage or transportation/shipment.

FIGS. 4A and 4B illustrate an alternate embodiment end cap 50 including an inner layer 52 constructed of any of various materials, such as a rigid or semi-rigid plastic, configured for installation over an end portion of a stack of trays in the same manner as shown in FIG. 2 illustrating the use of end caps 10. The inner layer 52 is at least partially covered with an outer layer of shock absorbing material 54. As a still further embodiment, the inner layer 52 can be constructed from a shock absorbing material, and the outer layer 54 can be a rigid material. In this latter case, the outer layer 54 serves the function of distributing an impact over a larger area of the shock absorbing material of the end cap 50. The structure of FIGS. 4A and 4B is illustrative of the concept of the present invention, and one alternate embodiment. Those skilled in the art will understand a variety of variations in design from reading the present disclosure, and these are also included in the present invention. For example, the end cap 50 be any of a variety of shapes, and in the case when the inner layer 52 is rigid material, shock absorbing material can also be of various configurations, such as separated components of material placed at various places, for example only on the corners or edges of the inner layer 52, instead of over the entire base and a substantial portion of the sidewalls that make up the outer layer 54 as described previously.

While the present invention has been described herein with reference to particular embodiments thereof, a latitude of modifications, various changes and substitutions are intended in the foregoing disclosure, and it will be appreciated that in some instances some features of the invention will be employed without a corresponding use of other features without departing from the spirit and scope of the invention as set forth in the appended claims.

1. An apparatus for protecting an end of a stack of trays comprising:
an end cap constructed of material including a shock absorbing material, the end cap including
a base having a perimeter that conforms to a shape of the end of the stack of trays;
side walls connected to and extending from the perimeter of the base thereby forming a cavity within which the end of the stack can be inserted.

2. An apparatus as recited in claim 1 wherein the perimeter has a rectangular shape.

3. An apparatus as recited in claim 1 wherein the side walls includes four connected wall sections each connected to a unitary base, each wall section interconnected at substantially right angles to an adjacent wall section, thereby forming an end cap of substantially rectangular box shape with an open top.

4. An apparatus as recited in claim 3 wherein the end cap is constructed as a single object.

5. An apparatus as recited in claim 4 wherein each of the base and the sidewalls include at least:
a first layer constructed of one of the shock absorbing material and a substantially non-compressible material; and
a second layer formed over the first layer constructed of the other of the shock absorbing material and the substantially non-compressible material.

6. An apparatus as recited in claim 5 wherein the first layer is the substantially non-compressible material and the second layer is the shock absorbing material.

7. An apparatus as recited in claim 6 wherein the first layer is the non-substantially compressible material and the second layer is the shock absorbing material.

8. An apparatus as recited in claim 5 wherein the perimeter has a rectangular shape.

9. An apparatus as recited in claim 8 wherein the side walls includes four connected wall sections, each section interconnected at a substantially right angle to an adjacent section, thereby forming an end cap of substantially rectangular box shape with an open top.

10. An apparatus as recited in claim 5 further including a plurality of holes in the base, the plurality of holes adapted to facilitate removal of the end cap from the stack of trays.

11. An apparatus as recited in claim 1 wherein the base and the sidewalls are formed as a plurality of components.

12. An apparatus as recited in claim 11, with each component including at least:
a first layer constructed of one of the shock absorbing material and a substantially non-compressible material; and
a second layer formed over the first layer constructed of the other of the shock absorbing material and the substantially non-compressible material.

13. An apparatus as recited in claim 12 wherein the first layer is the substantially non-compressible material and the second layer is the shock absorbing material.

14. An apparatus as recited in claim 12 wherein the first layer is the non-substantially compressible material and the second layer is the shock absorbing material.

15. An apparatus as recited in claim 11 wherein the plurality of components together, once inserted onto the end camp, form the perimeter with a rectangular shape.

16. An apparatus as recited in claim 15 wherein each components includes two wall sections, each wall interconnected at substantially a right angle to an adjacent section.

17. A method of protecting a stack of trays comprising:
placing first and second shock absorbing end caps over respective first and second opposing ends of the stack of trays, wherein each the first and second end caps are a single object constructed of a material including shock absorbing material that each envelope the first and second opposing ends of the stack of trays in a cavity.

18. A method as recited in claim 17, further including the step of impacting at least one of the end caps with another surface, the step of impacting causing the distribution of force in the shock absorbing material disposed within the at least one of the end caps.

19. A method as recited in claim 18 wherein the step of impacting causes the distribution of force directly on the shock absorbing material, and wherein the shock absorbing material is formed as one layer over another layer of substantially non-compressible material.

20. A method as recited in claim 18 wherein the step of impacting causes the distribution of force indirectly on the shock absorbing material, and wherein another layer of substantially non-compressible material is formed over a layer of the shock absorbing material.

21. The method according to claim 17 further including the step of removing each of the first and second shock absorbing end caps, the step of removing being facilitated by holes disposed in a base of each of the first and second shock absorbing end caps.
